(19) United States
(12) Patent Application Publication
(10) Pub. No.: US 2023/0397234 A1
(43) Pub. Date: Dec. 7, 2023

(54) SYSTEMS, METHODS, AND DEVICES FOR DYNAMICALLY ADAPTING UE CA CAPABILITY REPORTING

(71) Applicant: Apple Inc., Cupertino, CA (US)

(72) Inventors: Jose A Castelo Vega, San Jose, CA (US); David Boettger, San Jose, CA (US)

(21) Appl. No.: 18/314,283

(22) Filed: May 9, 2023

Related U.S. Application Data
(60) Provisional application No. 63/348,528, filed on Jun. 3, 2022.

(51) Int. Cl. H04W 72/51; H04W 24/02

(52) U.S. Cl. CPC H04W 72/51; H04W 24/02

(57) ABSTRACT

Techniques described herein include solutions for enabling user equipment (UEs) to report UE capability information based on deployed channel bandwidths (BWs) in each radio frequency (RF) band used by a base station. During an attached procedure, a base station may UE capability information from a UE and receive requested frequency band information (RFB) in response thereto. The RFB information (e.g., UE capability information) may be based on a comparison of an actual maximum BW for all possible CA combinations for the base station and Ω—a maximum aggregate BW supported by the UE. The UE may report the RFB to the base station for the CA combinations with a maximum BW that is less than or equal to Ω. After reporting, the UE may proceed with the attach procedure. Additional and alternative features and techniques are also described.

### REFERENCE TO RELATED APPLICATION

This application claims the benefit of U.S. Provisional Application No. 63/348,528, filed on Jun. 3, 2022, the contents of which are hereby incorporated by reference in their entirety.

### FIELD

This disclosure relates to wireless communication networks and wireless device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology often includes procedures for enabling user equipment (UEs) to send and receive information about device capabilities.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of data structures that include maximum and minimum bandwidths (BW) for bands and carrier aggregation (CA) combinations.

FIG. 2 is a diagram of an example overview according to one or more implementations described herein.

FIG. 3 is an example network according to one or more implementations described herein.

FIG. 4 is a diagram of an example process for dynamically reporting user equipment (UE) CA capability according to one or more implementations described herein.

FIG. 5 is a diagram of example data structure according to one or more implementations described herein.

FIG. 6 is a diagram of example data structure according to one or more implementations described herein.

FIG. 7 is a figure of another example of a data structure according to one or more implementations described herein.

FIG. 8 is a diagram of example CA combinations and corresponding conditions according to one or more implementations described herein.

FIG. 9 is a diagram of an example data structure of information and logical associations between information relating to CA combinations and corresponding UE behaviors.

FIG. 10 is a diagram of an example process for dynamically adjusting UE CA capability reporting based on a BW deficit according to one or more implementations described herein.

FIG. 11 is a diagram of example CA combinations and corresponding BW deficits β according to one or more implementations described herein.

FIG. 12 is a diagram of an example data structure of information and logical associations between information relating to CA combinations and corresponding UE capability information and behaviors.

FIG. 13 is a diagram of an example process for dynamically adjusting UE CA capability reporting based on pre-loaded and location-specific CA combinations according to one or more implementations described herein.

FIG. 14 is a diagram of an example of dynamically reporting UE CA capability according to one or more implementations described herein.

FIG. 15 is a diagram of an example of components of a device according to one or more implementations described herein.

FIG. 16 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, and other network nodes. Doing so may provide UEs with various services, including call services, messaging services, browsing services, geographic services, and more. Wireless networks may operate according to one or more wireless standards, including those defined by the 3rd generation partnership project (3GPP).

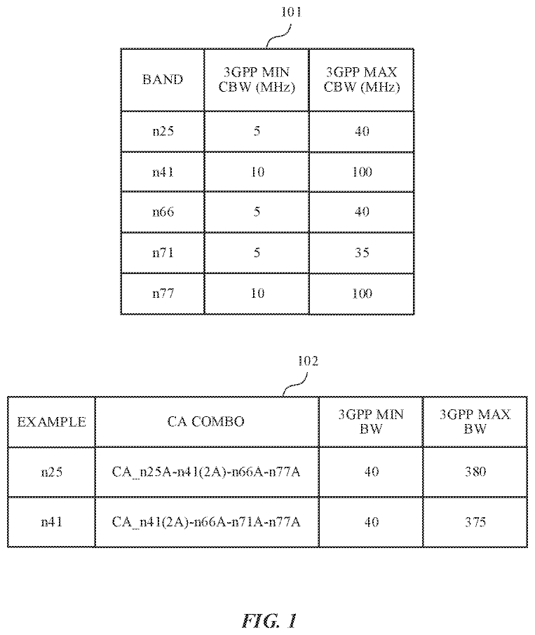

3GPP communication standards define a minimum and maximum permissible channel bandwidth (CBW) per radio frequency (RF). Table 101 of FIG. 1 provides examples of such minimums and maximums. These limits together imply a maximum total aggregated bandwidth for a given carrier aggregation (CA) combination as shown in table 102 of FIG. 1. At times, the maximum aggregate bandwidth supported in a UE implementation (which may be referred to as “Ω”) may be lower than the maximum possible aggregated bandwidth permitted by 3GPP. Additionally, the maximum aggregate bandwidth deployed in real networks may be substantially lower than the maximum possible aggregated bandwidth permitted by 3GPP.

Thus, there exists an implementation challenge about if/when it would be beneficial for a UE to inform the network about the capability of the UE to support aggregation combinations with an aggregated bandwidth that may in theory (e.g., at the maximum permitted by the standards) exceed Ω (e.g., the maximum aggregate bandwidth supported by the UE) when in practice it might not (e.g., at the maximum aggregate bandwidth actually deployed by the network). The crux of this issue may be characterized as the UE not being aware of the channel bandwidths actually deployed in a given network. As such, UEs are often configured conservatively by only signaling support for aggregation combinations with a maximum theoretical bandwidth within a maximum capability of the UE. That is, if the maximum aggregate bandwidth based on the maximum bandwidth defined by the standards for a particular CA combination exceeds Ω, the UE may not report support for that combination even in situations where the maximum aggregate bandwidth based on the actually deployed bandwidths by the network do not exceed Ω. However, this is not an optimized solution for either the UE or the network—since CA combinations that are supported by the UE and by the network may go underutilized or not utilized at all (e.g., since only the UE signaled combinations may be activated by the network).

Techniques, described herein, may include solutions for enabling UEs to report UE capability information based on actually deployed CBWs in each RF band used by a base station. For example, during an attached procedure, a UE may receive a UE capability request message from a base station. The UE capability request message may include a request for requested frequency band (RFB) information, which may include information about one or more frequency bands being supported by UE. The UE capability request message may include a “hint” or indication of an actual CBW per band implemented by base station 120. The actual CBW for a particular band may be less than a theoretical or standard-defined maximum CBW for a particular band.

The UE may use the actual CBW per band to calculate a maximum total aggregated bandwidth (BW) for all possible CA combinations for the base station and compare them each against Ω—the maximum aggregate BW supported by the UE. The UE may report UE capability information with the RFB information to the base station. The RFB information may indicate one or more CA combinations with a maximum BW that is less than or equal to Q. After reporting that the UE may support one or more CA combinations, the UE may proceed with the attach procedure. As such, one or more of the techniques described herein may enable better UE capability reporting and superior CA utilization by causing the UE to report CA capabilities based on RFB information from the base station.

In some implementations, when a total BW for a CA combination is above Ω (e.g., the maximum aggregate BW supported by the UE), the UE may still report that the CA combination is supported. In such scenarios, the UE may determine a BW deficit based on a difference between the total BW for the CA and Ω and may distribute the BW deficit among one or more lower priority bands. In some implementations, the UE may also, or alternatively, determine support for CA combinations based on a pre-load, or stored, configuration file containing an optimized setting for all CA combinations that exceeds a maximum aggregate BW supported by the UE. In some implementations, the UE may also, or alternatively, determine support for CA combinations based on information collected in a centralized database and deployed to UEs throughout the network. Accordingly, the techniques described herein provide various solutions to enabling UEs to report having the capability of using (e.g., supporting) CA combinations with a maximum aggregation BW that exceeds the maximum CA BW supported by the UE.

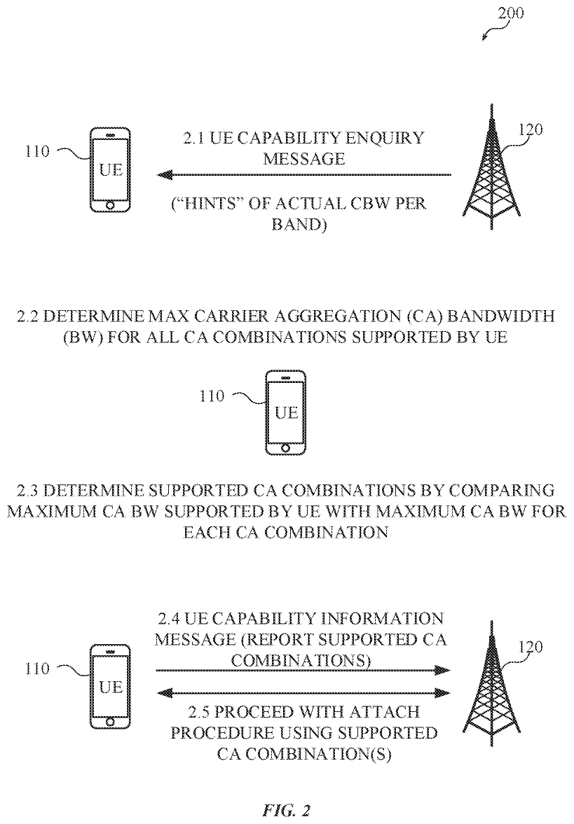

FIG. 2 is a diagram of an example overview 200 according to one or more implementations described herein. As shown, the example overview 200 may include a UE 110 and base station 120. During an attach procedure, base station 120 may request frequency band information from UE 110 using a UE capability enquiry message (at 2.1). The UE capability enquiry message may request RFB information, which may be an indication of frequency bands supported by the UE. The UE capability enquiry message may include a “hint” of an actual CBWs per band implemented by base station 120. The actual CBW for a particular band may be less than a theoretical or standard-defined maximum CBW for a particular band.

UE 110 may use the “hint” or actual CBW information to determine an actual maximum BW for all CA combinations supported by UE 110 (at 2.2) and may determine which CA combinations are supported by comparing the actual maximum CA BW supported by UE 110 with the actual maximum CA BW corresponding to each CA combination (at 2.3). UE 110 may communicate (or report) to base station 120 which CA combinations are supported by UE 110 (at 2.4) and one or more of the supported CA combinations may be used by base station 120 and UE 110 in completing the attach procedure and/or communicating with one another thereafter (at 2.5). Accordingly, one or more of the techniques described herein may improve CA usage based on the maximum CA BW supported by UE 110 and actual CBW maximums (instead of theoretical CBW maximums) used by base station 120. Examples of additional features, operations, and/or processes are also described below with references to the Figures.

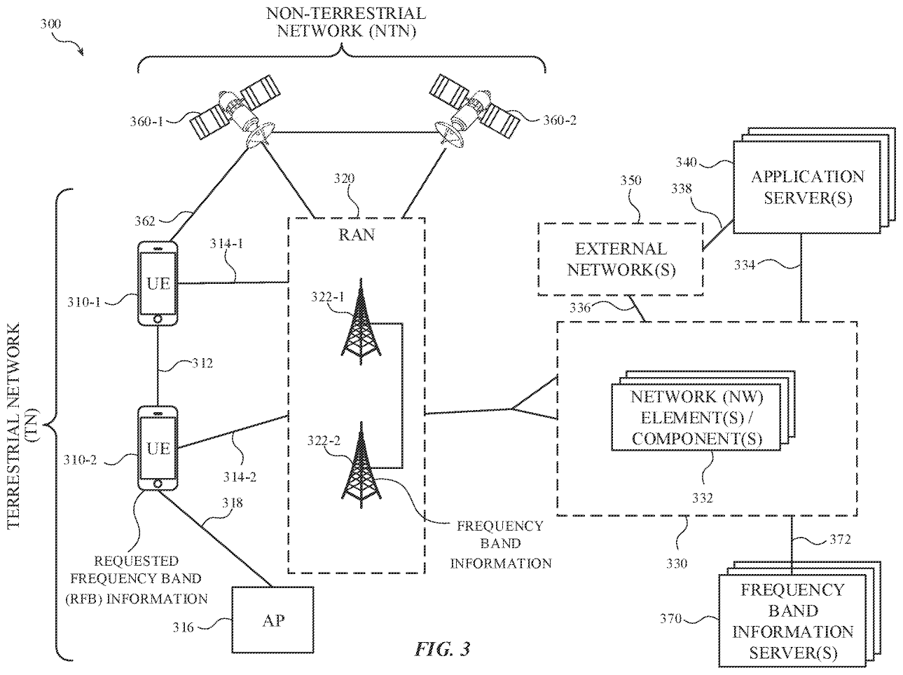

FIG. 3 is an example network 300 according to one or more implementations described herein. Example network 300 may include UEs 310-1, 310-2, etc. (referred to collectively as “UEs 310” and individually as “UE 310”), a radio access network (RAN) 320, a core network (CN) 330, application servers 340, external networks 350, and satellites 360-1, 360-2, etc. (referred to collectively as “satellites 360” and individually as “satellite 360”). As shown, network 300 may include a non-terrestrial network (NTN) comprising one or more satellites 360 (e.g., of a global navigation satellite system (GNSS)) in communication with UEs 310 and RAN 320.

The systems and devices of example network 300 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 300 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 310 may include smartphones (e.g., handheld touchscreen mobile computing devices connectable to one or more wireless communication networks). Additionally, or alternatively, UEs 310 may include other types of mobile or non-mobile computing devices capable of wireless communications, such as personal data assistants (PDAs), pagers, laptop computers, desktop computers, wireless handsets, etc. In some implementations, UEs 310 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 310 may communicate and establish a connection with one or more other UEs 310 via one or more wireless channels 312, each of which may comprise a physical communications interface/layer. The connection may include an M2M connection, MTC connection, D2D connection, etc. In some implementations, UEs 310 may be configured to discover one another, negotiate wireless resources between one another, and establish connections between one another, without intervention or communications involving RAN node 322 or another type of network node. In some implementations, discovery, authentication, resource negotiation, registration, etc., may involve communications with RAN node 322 or another type of network node.

UEs 310 may communicate and establish a connection with (e.g., be communicatively coupled) with RAN 320, which may involve one or more wireless channels 314-1 and 314-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 322-1 and 322-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 330. Additionally, at least one of the MN or the SN may be operated with shared spectrum channel access, and functions specified for UE 310 can be used for an integrated access and backhaul mobile termination (IAB-MT). Similar for UE 310, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network nod 322.

As shown, UE 310 may also, or alternatively, connect to access point (AP) 316 via connection interface 318, which may include an air interface enabling UE 310 to communicatively couple with AP 316. AP 316 may comprise a wireless local area network (WLAN), WLAN node, WLAN termination point, etc. The connection 318 may comprise a local wireless connection, such as a connection consistent with any IEEE 702.11 protocol, and AP 316 may comprise a wireless fidelity (Wi-Fi®) router or other AP. While not explicitly depicted in FIG. 3, AP 316 may be connected to another network (e.g., the Internet) without connecting to RAN 320 or CN 330.

RAN 320 may include one or more RAN nodes 322-1 and 322-2 (referred to collectively as RAN nodes 322, and individually as RAN node 322) that enable channels 314-1 and 314-2 to be established between UEs 310 and RAN 320. RAN nodes 322 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 322 may include a roadside unit (RSU), a transmission reception point (TRxP or TRP), and one or more other types of ground stations (e.g., terrestrial access points). In some scenarios, RAN node 322 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 360 may operate as bases stations (e.g., RAN nodes 322) with respect to UEs 310. As such, references herein to a base station, RAN node 322, etc., may involve implementations where the base station, RAN node 322, etc., is a terrestrial network node and also to implementation where the base station, RAN node 322, etc., is a non-terrestrial network node (e.g., satellite 360).

Some or all of RAN nodes 322, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 322; a media access control (MAC)/physical (PHY) layer split wherein RRC, PDCP, radio link control (RLC), and MAC layers may be operated by the CRAN/vBBUP and the PHY layer may be operated by individual RAN nodes 322; or a “lower PHY” split wherein RRC, PDCP, RLC, MAC layers and upper portions of the PHY layer may be operated by the CRAN/vBBUP and lower portions of the PHY layer may be operated by individual RAN nodes 322. This virtualized framework may allow freed-up processor cores of RAN nodes 322 to perform or execute other virtualized applications.

In some implementations, an individual RAN node 322 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 320 or by a server pool (e.g., a group of servers configured to share resources) in a similar manner as the CRAN/vBBUP. Additionally, or alternatively, one or more of RAN nodes 322 may be next generation eNBs (i.e., gNBs) that may provide evolved universal terrestrial radio access (E-UTRA) user plane and control plane protocol terminations toward UEs 310, and that may be connected to a 5G core network (5GC) 330 via an NG interface.

Any of the RAN nodes 322 may terminate an air interface protocol and may be the first point of contact for UEs 310. In some implementations, any of the RAN nodes 322 may fulfill various logical functions for the RAN 320 including, but not limited to, radio network controller (RNC) functions such as radio bearer management, uplink and downlink dynamic radio resource management and data packet scheduling, and mobility management. UEs 310 may be configured to communicate using orthogonal frequency-division multiplexing (OFDM) communication signals with each other or with any of the RAN nodes 322 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

Further, RAN nodes 322 may be configured to wirelessly communicate with UEs 310, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 310 and the RAN nodes 322 may operate using licensed assisted access (LAA), eLAA, and/or feLAA mechanisms. In these implementations, UEs 310 and the RAN nodes 322 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 310 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 310 and the RAN nodes 322 may also operate using stand-alone unlicensed operation where the UE may be configured with a PCell, in addition to any SCells, in unlicensed spectrum.

As shown, RAN 320 may be connected (e.g., communicatively coupled) to CN 330. CN 330 may comprise a plurality of network elements 332, which are configured to offer various data and telecommunications services to customers/subscribers (e.g., users of UEs 310) who are connected to the CN 330 via the RAN 320. In some implementations, CN 330 may include an evolved packet core (EPC), a 5G CN, and/or one or more additional or alternative types of CNs. The components of the CN 330 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 330 may be referred to as a network slice, and a logical instantiation of a portion of the CN 330 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 330, application servers 340, and external networks 350 may be connected to one another via interfaces 334, 336, and 338, which may include IP network interfaces. Application servers 340 may include one or more server devices or network elements (e.g., virtual network functions (VNFs) offering applications that use IP bearer resources with CN 330 (e.g., universal mobile telecommunications system packet services (UMTS PS) domain, LTE PS data services, etc.). Application servers 340 may also, or alternatively, be configured to support one or more communication services (e.g., voice over IP (VoIP sessions, push-to-talk (PTT) sessions, group communication sessions, social networking services, etc.) for UEs 310 via the CN 330. Similarly, external networks 350 may include one or more of a variety of networks, including the Internet, thereby providing the mobile communication network and UEs 310 of the network access to a variety of additional services, information, interconnectivity, and other network features.

During an attach procedure between UE 110 and RAN node 322 (and/or AP 316, or satellite 360) UE 310 may request frequency band information from RAN node 322 and may receive RFB information in response thereto. The RFB may include an actual CBW used by RAN node 322 on a per-band basis. UE 110 may use the actual CBW to determine an actual maximum CA BW for CA combinations supported by UE 310 and may determine which CA combinations are supported by comparing the actual maximum CA BW supported by UE 310 with the actual maximum CA BW corresponding to each CA combination. UE 110 may communicate to base station 322 which CA combinations are supported by UE 310, and one or more of the supported CA combinations may be used by base station 322 and UE 310 to complete the attach procedure and/or communicate with one another thereafter.

Frequency band information server 370 may include one or more servers, server devices, or network elements (e.g., VNFs) configured to send, receive, process, and/or store channel, band, BW, frequency, cell information, etc. Frequency band information server 370 may communicate with CN via connection or interface 372, which may include IP network interfaces. Frequency band information server 370 may include, manage, and/or have access to a database and/or other type of data repository, which may store one or more types of data. As described herein, frequency band information server 370 may receive, process, and/or store information to enable or facilitate one or more implementations described herein. For example, frequency band information server 370 may collect channel, band, BW, frequency, cell information, CA combinations, and/or one or more other types of information from UEs 310 from a geographic area, cell, city, country, state, province, country, hemisphere, the world, etc. Frequency band information server 370 may distribute one or all of the information to one or more UEs 310 so that, for example, a UE 310 may have information about a particular cell (e.g., RAN node 310) so as to perform one or more of the techniques described herein. As such, frequency band information server 370 may provide a centralized data repository and/or distribution source for frequency band and/or other types of information throughout the world.

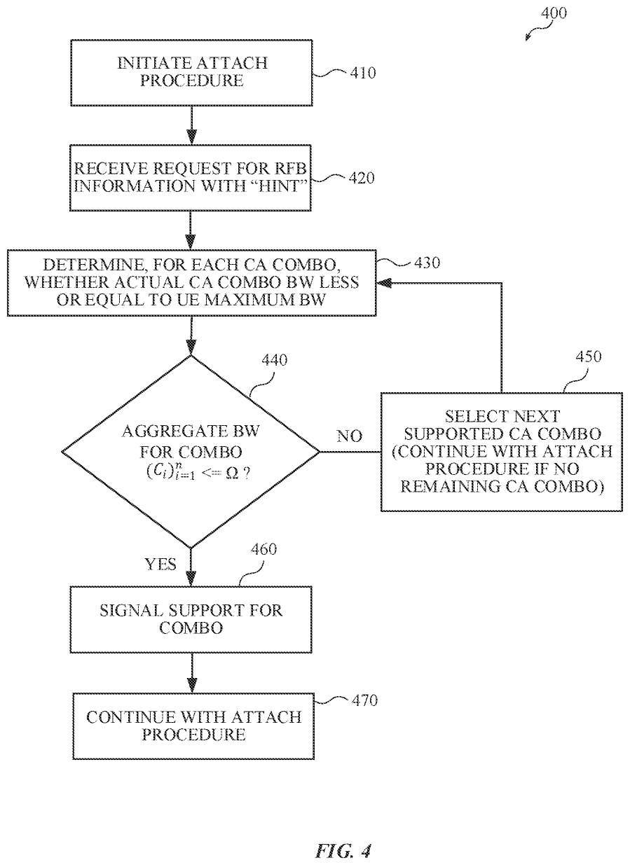

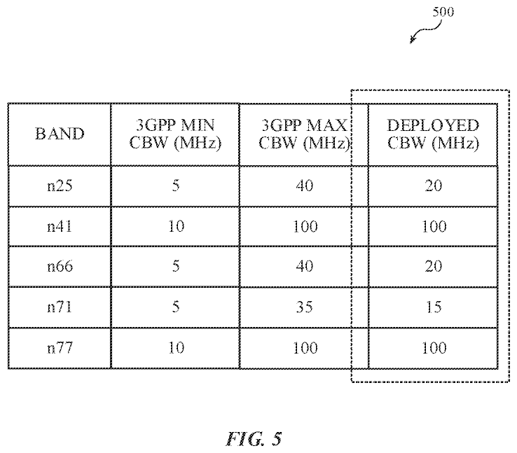

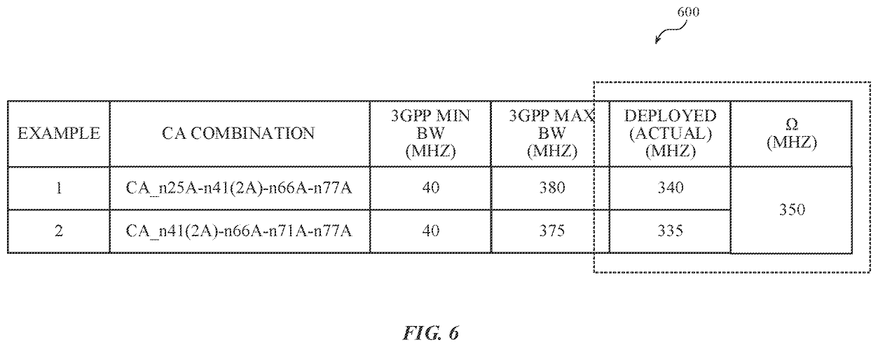

FIG. 4 is a diagram of an example process 400 for dynamically reporting UE CA capability according to one or more implementations described herein. Process 400 may be implemented by UE 310. In some implementations, Some or all of process 400 may be performed by one or more other systems or devices, including one or more of the devices of FIG. 3, such as base station 322, CN 330, and frequency band information server 370. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or process depicted in FIG. 4. Example process 400 is described below with periodic reference to FIGS. 5-6.

As shown, process 400 may include initiating an attach procedure (block 410). For example, UE 310 may initiate an attach (or attachment) procedure involving base station 322. The attach procedure may be consistent with a communications standard such as 4G, 5G, 6G, etc. Process 400 may include receiving a request for frequency band information via a UE capability enquiry message (block 420). For example, UE 310 may receive a request for RFB information from base station 322 after initiating, and/or as part of, an attach procedure. In some implementations, base station 322 may provide UE 310 with RFB information as a matter of course. The UE capability enquiry message may include a “hint” or indications of an actual CBW per band implemented by base station 120. The actual CBW for a particular band may be less than a theoretical or standard-defined maximum CBW for a particular band.

FIG. 5 is a diagram of example data structure 500 according to one or more implementations described herein. Data structure 500 may include an example of one or more types of information that may be included in UE capability enquiry message or one or more other types of messages. Additionally, any of data structure 500 may be stored by UE 310 and/or base station 322, and/or communicated between UE 310 and base station 322. Data structure 500 may include one or more fewer, additional, differently ordered, and/or arranged types of information than those shown in FIG. 5. For example, in some implementations, some of the types of information of data structure 500 may be communicated, between UE 310 and base station 322, at different times and/or via different channels or messages. As such, data structure 500 is provided as non-limiting example of information that may be used to implement one or more of the techniques described herein.

Data structure 500 may be an example of some, or all, of the information that base station 322 may provide to UE 310 regarding actual CBWs per band (e.g., the “hint”). As shown, data structure 500 may include an arrangement of bands supported by base station 322 (e.g., indicated by identifiers n25, n41, etc.) and a corresponding 3GPP minimum CBW, 3GPP maximum CBW, and an actual or deployed CBW. The actual or deployed CBW may indicate the actual BW base station 322 is using for the band, which may be the same or different than either the minimum or maximum CBW.

Referring again to FIG. 4, process 400 may include determining, for each CA combination, whether an actual CA combination BW for the CA combination (referred to herein at times as ((Cᵢ)ᵢ₌₁ⁿ)) is less than or equal to a maximum bandwidth supported by UE 310 (which may be referred to herein as Ω) (block 430). For example, CBW information may include frequency bands supported by base station 322. UE 310 may use the CBW information to determine different CAs and determine a maximum CA BW for each or all CAs. The maximum CA BWs determined by UE 310 may be based on the actual BW (e.g., based on the CBWs) being used by base station 322 instead of, for example, the maximum bandwidth allowed per the 3GPP standards. A maximum BW based on an actual BW being used may be referred to herein as the “actual maximum BW,” “actual BW,” the “base station specific BW,” and the like). UE 310 may also determine a maximum BW supported by UE 310, select a first CA determined by UE 310, and compare the actual maximum bandwidth of the first CA to the maximum BW supported by UE 310 to determine whether UE 310 supports the first CA.

FIG. 6 is a diagram of example data structure 600 according to one or more implementations described herein. Data structure 600 may include an example of the types of information that may be included in RFB information or one or more other types of data sets or messages. Additionally, any of data structure 600 may be stored by UE 310 and/or base station 322, and/or communicated between UE 310 and base station 322. Data structure 600 may include one or more fewer, additional, differently ordered, and/or arranged types of information than those shown in FIG. 6 For example, in some implementations, some of the types of information of data structure 600 may be communicated, between UE 310 and base station 322, at different times and/or via different channels or messages. As such, data structure 600 is provided as non-limiting example of information that may be used to implement one or more of the techniques described herein.

Data structure 600 may be an example of CAs (e.g., examples 1 and 2). Each CA may include a combination of carriers (e.g., n25A-n41(2A)-n66A-n77A and CA_n41(2A)-n66A-n71A-n77A). Each CA may also include a 3GPP min BW, a 3GPP max BW, a deployed or actual BW. UE 310 may determine these values based on the RFB information received from base station 322. Data structure 600 may also indicate Ω, which may be a maximum aggregate BW supported by UE 310. As shown, while Ω may be less than the 3GPP maximum BW for both example CAs 1 and 2, Ω may be greater than the actual CA BW of example CAs 1 and 2. As such, by enabling UE 310 to compare Ω to an actual CA BW instead of a 3GPP maximum CA BW, UE 310 may be able to report to base station 322 that UE 310 is capable of supporting, and therefore using, a CA that UE 310 may otherwise not be able to use for basing capability reporting on the 3GPP maximum CA BW.

Referring to FIG. 4, when the aggregated BW for a combination of carriers (e.g., (Cᵢ)ᵢ₌₁ⁿ)) is greater than less than or equal to a maximum aggregate BW supported by UE 310 (e.g., Ω) (block 440—No), process 400 may include selecting a next CA combination (450). For example, UE 310 may determine, or select a previously determined, CA combination and determine whether the corresponding CA combination BW is less than or equal to a maximum aggregate BW supported by UE 310 (block 430). When there are no more CA combinations left to evaluate, UE 310 may instead proceed with the attach procedure (e.g., without reporting support for a CA combination based on the actual CA combination BW). In such a scenario, UE 310 may not signal support for a CA combination that exceeds a maximum aggregate BW supported by UE 310 (e.g., Ω).

When the aggregated BW for a combination of carriers (e.g., (Cᵢ)ᵢ₌₁ⁿ)) is less than or equal to a maximum aggregate BW supported by UE 310 (e.g., Ω) (block 440—Yes), process 400 may include signaling support for the CA combination (block 460). For example, UE 310 may indicate, to base station 322, that UE 310 is capable of supporting a particular CA combination upon determining that the maximum BW supported by UE 310 is greater than to the actual maximum bandwidth of the CA combination. Process 400 may also include continuing with the attach procedure (block 470). For example, UE 310 may proceed with the attach procedure regarding base station 322 upon, or after, reporting support for a CA combination.

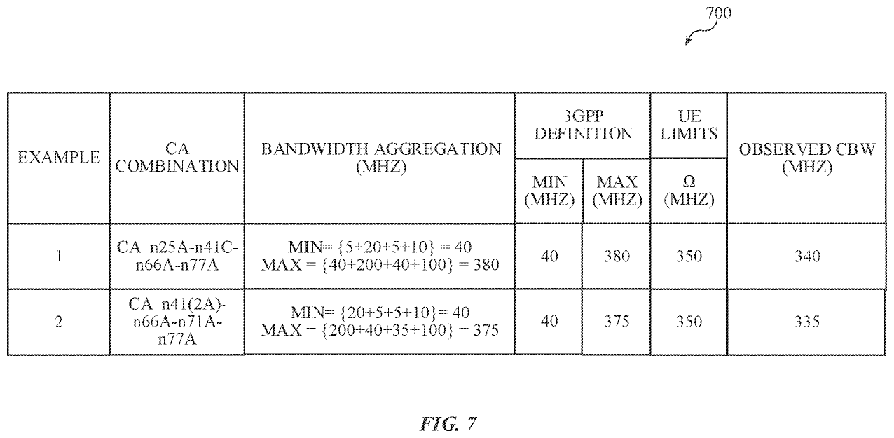

FIG. 7 is a figure of another example of a data structure 700 according to one or more implementations described herein. As shown, examples 1 and 2 of data structure 700 may include CA combinations (e.g., CA_n25A-n41C-n66A-n77A and CA_n41(2A)-n66A-n71A-n77A) an aggregated minimum BW (e.g., 40 MHz) and an aggregated maximum BW (e.g., 380 MHz and 375 MHz. Examples 1 and 2 of data structure 700 may also include a UE BW limit (e.g., Ω) of 350 MHz, and an observed or actual CA combination BW (or CBW) or 340 MHz and 335 MHz According to the techniques described herein, even though the 3GPP maximum BWs of the CAs of examples 1 and 2 (e.g., 380 MHz and 375 MHz) exceed the UE limit of 350 MHz, UE 310 may still be able to report support for, and use, the CAs of examples 1 and 2 since the actual or observed CA combination BWs of 340 MHz and 335 MHz are less than or equal to the UE BW limit.

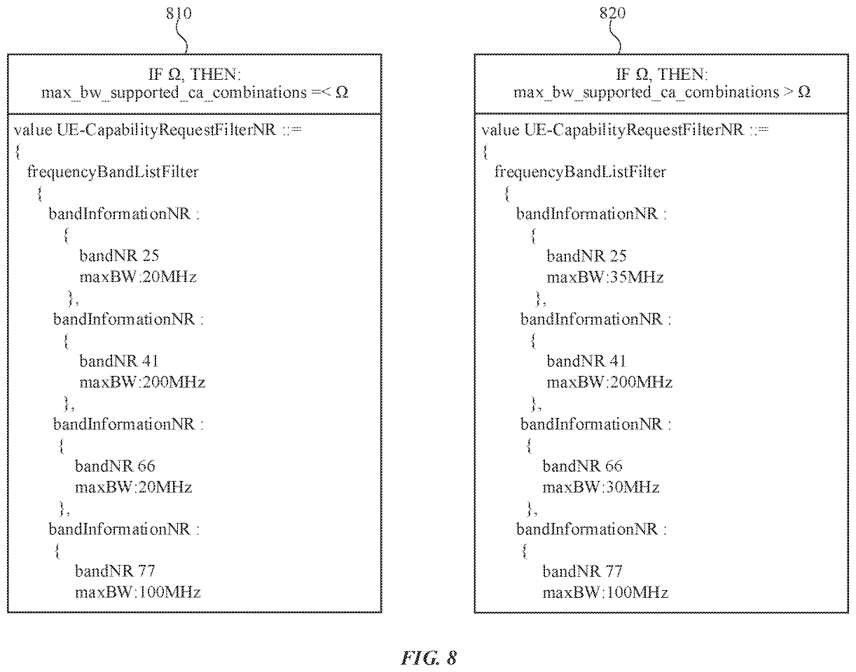

FIG. 8 is a diagram of example CA combinations 810 and 820 and corresponding conditions according to one or more implementations described herein. Example CA combination 810 may include a set of carriers with an actual CA combination BW that is equal to or lower than a maximum BW capability of UE 310 (e.g., Ω). Assume Ω is 350 MHz. Since the carriers of CA combination 810 include actual BW maximums of 20 MHz, 200 MHz, 20 MHz, and 100 MHz, the total actual CA combination bandwidth is 340, which is less than Ω. As such, UE 310 may indicate to base station 322 that UE 310 supports CA combination 810. The actual BW maximums may be examples of CBW or “hints” provided by base station 322 to UE 210 via a UE capability request message. By contrast, since the carriers of CA combination 820 include actual BW maximums of 35 MHz, 200 MHz, 30 MHz, and 100 MHz, the total actual CA combination bandwidth is 365, which is greater than Ω. As such, UE 310 may not indicate support for CA combination 820. The actual BW maximums may be examples of CBW or “hints” provided by base station 322 to UE 210 via a UE capability request message.

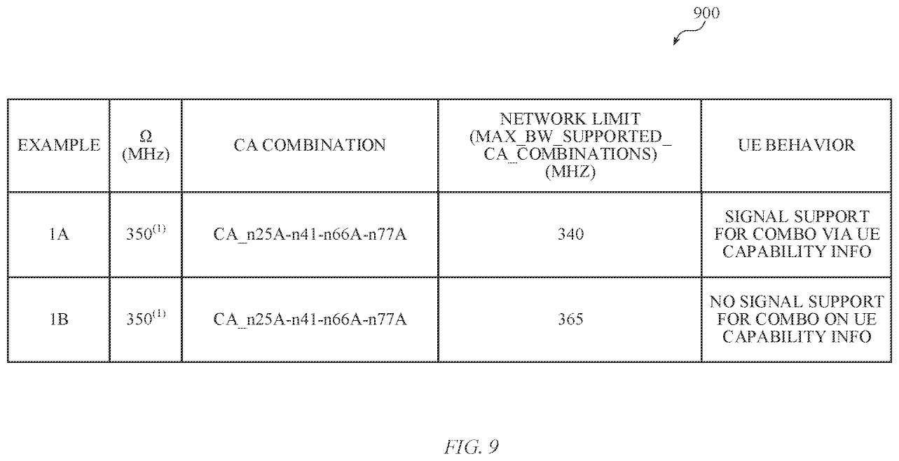

FIG. 9 is a diagram of an example data structure 900 of information and logical associations between information relating to CA combinations and corresponding UE behaviors. Example 1A may correspond to CA combination 810 of FIG. 8, and example 1B of FIG. 9 may correspond to CA combination 820 of FIG. 8.

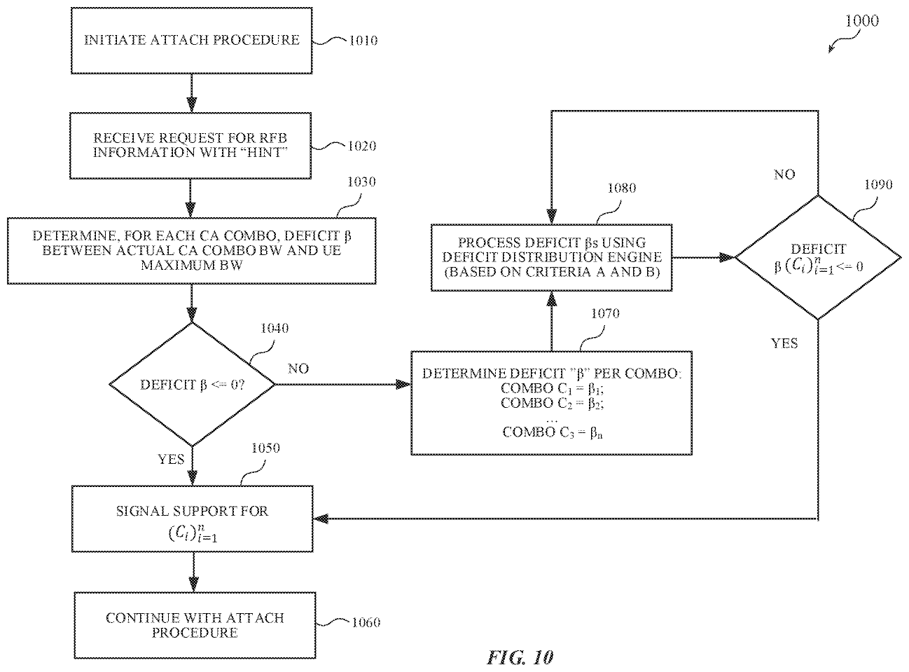

FIG. 10 is a diagram of an example process 1000 for dynamically adjusting UE CA capability reporting based on a BW deficit according to one or more implementations described herein. Process 1000 may be implemented by UE 310. In some implementations, some or all of process 1000 may be performed by one or more other systems or devices, including one or more of the devices of FIG. 3, such as base station 322, CN 330, and frequency band information server 370. Additionally, process 1000 may include one or more fewer, additional, differently ordered and/or arranged operations than those shown in FIG. 9 In some implementations, some or all of the operations of process 1000 may be performed independently, successively, simultaneously, etc., of one or more of the other operations of process 1000.

As shown, process 1000 may include initiating an attach procedure (block 1010). For example, UE 310 may initiate an attach (or attachment) procedure involving base station 322. The attach procedure may be a process involving a series of communications between UE 310 and base station 322 to enable UE 310 to register with and/or connect to base station 322. In some implementations, the attach procedure may be consistent with, or based on, a communications standard such as 4G, 5G, 6G, etc.

Process 1000 may also include receiving a request for frequency band information via a UE capability enquiry message (block 420). For example, UE 310 may receive a request for RFB information from base station 322 after initiating, and/or as part of, an attach procedure. Process 1000 may include determining, for each CA combination, a deficit β value (block 1030). The deficit β value may be equal to an actual maximum BW of a CA combination, minus the maximum BW capacity of UE 310. As such, UE 310 may determine an actual maximum capacity of a CA combination based on the CBW information received from base stations 322 and apply the actual maximum capacity of the CA combination and a maximum BW capacity of UE 310 to determine a corresponding deficit β value. A deficit β value of 0 or less may indicate that the BW capacity of UE 310 is adequate for the actual maximum BW of the CA combination.

When deficit β value is less than or equal to 0 (1040—Yes), process 1000 may include signaling support for the CA combination ((Cᵢ)ᵢ₌₁ⁿ) (block 1050) and continuing with the attach procedure (block 1060). For example, UE 310 may signal to base station 322 that UE 310 supports the CA combination and proceed with completing the attach procedure. A deficit β value of greater than 0 may indicate that the maximum BW capacity of UE 310 is inadequate relative to the actual maximum BW of the CA combination. Consequently, when deficit β value is greater than 0 (1040—No), process 1000 may include determining a deficit β value for one or more CA combinations (e.g., C₁, C₂, etc.) (at 1070). Process 1000 may include processing the deficit β values using a deficit distribution engine (block 1080).

The deficit distribution engine may include one or more rules, instructions, parameters, etc., for reducing a deficit β value of a CA combination by reducing the BW on lower priority bands. The deficit distribution engine may operate based on one or more criteria. For example, a first criteria (which may be referred to as “criteria A”) may be to reduce the BW on lower priority bands through frequency division duplexing (FDD) bands (e.g., starting with low bands, then mid-band, and then high bands). After FDD, a second criteria (which may be referred to as “criteria B”) may be applied, which may include time division duplexing (TDD) bands. Reducing the BW of lower priority bands, a maximum BW capability of UE 310 to use the CA combination may improve, thus lowering reducing the deficit β value to 0 or less.

Process 1000 may include determining whether a reduced deficit β, for a CA combination ((Cᵢ)ᵢ₌₁ⁿ) is less than or equal to 0 (block 1090). For example, UE 310 may determine whether a reduced deficit β, for a CA combination (Cᵢ)ᵢ₌₁ⁿ) is less than or equal to 0. If so (block 1090—No), process 1000 may include using the deficit distribution engine to further reduce the deficit β value. When a deficit β value is found to be less than or equal to 0 (block 1090—Yes), process 1000 may proceed by signaling support for the CA combination (Cᵢ)ᵢ₌₁ⁿ) (block 1050) and continuing with the attach procedure (block 1060). For example, UE 310 may signal to base station 322 that UE 310 supports the CA combination and proceed with completing the attach procedure. In some implementations, UE 310 may discontinue processing deficit βs when a suitable CA combination is identified (e.g., one with a deficit β less than or equal to 0).

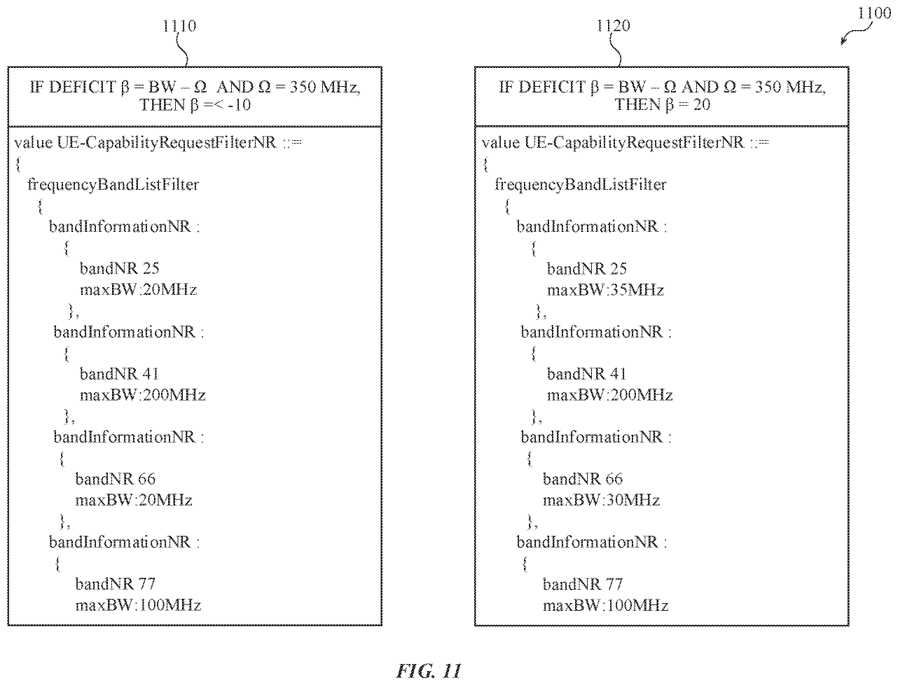

FIG. 11 is a diagram of example CA combinations 1110 and 1120 and corresponding BW deficits β according to one or more implementations described herein. UE 310 may determine deficits β for a CA combination by subtracting Ω from an actual CA combination BW of the CA combination. For purposes of explaining FIG. 11, assume that Ω is 350 MHz; as such, deficit β for CA combination 1110 may be −10 MHz, since the carriers of CA combination 810 include actual BW maximums of 20 MHz, 200 MHz, 20 MHz, and 100 MHz, and 340 MHz−350 MHz=−10 MHz. The actual BW maximums may be examples of CBW or “hints” provided by base station 322 to UE 210 via a UE capability request message. In such a scenario, UE 310 may indicate to base station 322 that UE 310 supports CA combination 1110. By contrast, deficit β for CA combination 1120 may be 20 MHz as the carriers of CA combination 1120 include actual BW maximums of 35 MHz, 200 MHz, 30 MHz, and 100 MHz, and 370 MHz−350 MHz=20 MHz. The actual BW maximums may be examples of CBW or “hints” provided by base station 322 to UE 210 via a UE capability request message. In such a scenario, UE 310 may update channelBWs-DL bits (e.g., from right to left) for lower priority bands until β is equal or less than 0, upon which UE 310 may indicate support for CA combination 1120.

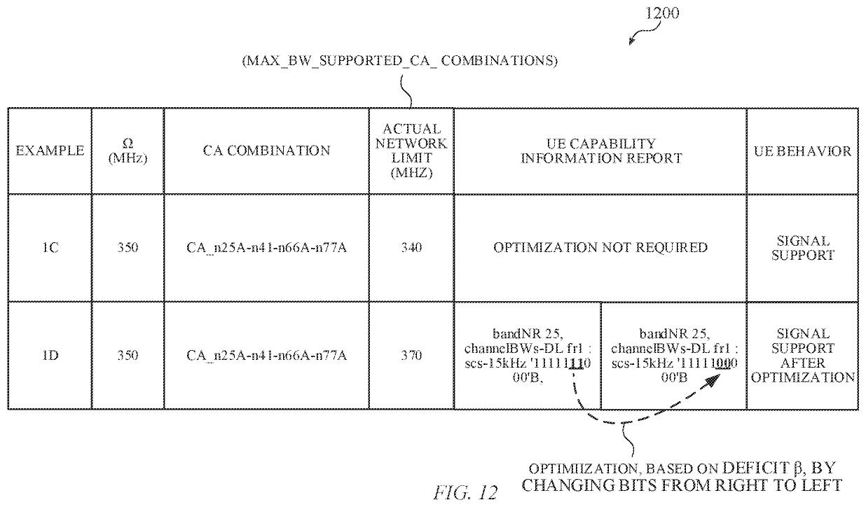

FIG. 12 is a diagram of an example data structure 1200 of information and logical associations between information relating to CA combinations and corresponding UE capability information and behaviors. Example 1C may correspond to CA combination 1110 of FIG. 11, and example 1D may correspond to CA combination 1120 of FIG. 11. As shown in FIG. 12, UE 310 may update channelBWs-DL bits (e.g., from right to left) for lower priority bands until β is equal or less than 0, upon which UE 310 may indicate support for CA combination 1120.

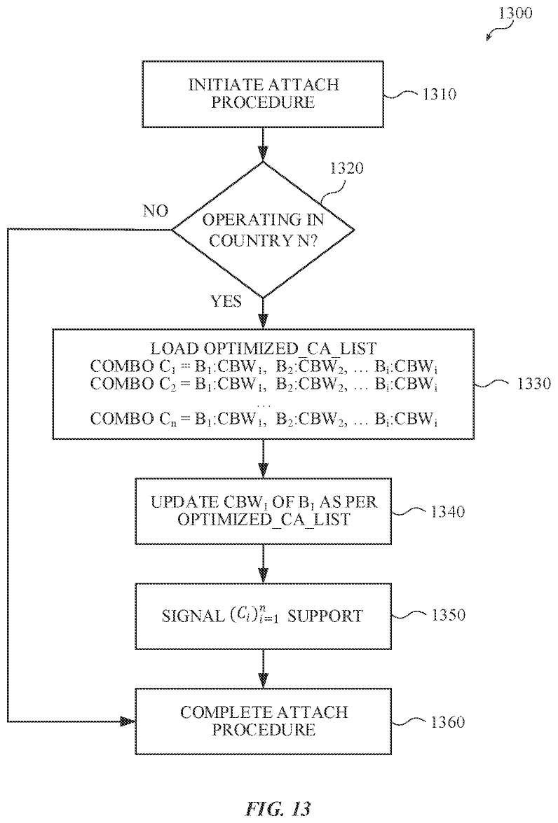

FIG. 13 is a diagram of an example process 1300 for dynamically adjusting UE CA capability reporting based on pre-loaded and location-specific CA combinations according to one or more implementations described herein. Process 1300 may be implemented by UE 310. In some implementations, some or all of process 1300 may be performed by one or more other systems or devices, including one or more of the devices of FIG. 3, base station 322, CN 330, and frequency band information server 370. Additionally, process 1300 may include one or more fewer, additional, differently ordered and/or arranged operations than those shown in FIG. 9 In some implementations, some or all of the operations of process 1300 may be performed independently, successively, simultaneously, etc., of one or more of the other operations of process 1300.

As shown, process 1300 may include initiating an attach procedure (block 1310). For example, UE 310 may initiate an attach (or attachment) procedure involving base station 322. The attach procedure may be a process involving a series of communications between UE 310 and base station 322 to enable UE 310 to register with and/or connect to base station 322. In some implementations, the attach procedure may be consistent with, or based on, a communications standard such as 4G, 5G, 6G, etc.

Process 1300 may include determining whether UE 310 in a particular country (N) (block 1340). For example, UE 310 may be pre-loaded with a configuration file saved in non-volatile memory containing an optimized settings for all CA combinations that exceed a maximum aggregated bandwidth supported. The configuration file may be activated at runtime, every time UE 310 initiates a boot up sequence, returns from being in an area without service, etc. Additionally, or alternatively, the configuration file may be defined as a dictionary of paired values that include: {“CA combo”: “optimized CBW per band”} and loaded on an operator by operator basis. In some implementations, UE 310 may store multiple optimized CA list, some of which may be particular to one or more countries and/or one or more operators.

When UE 310 is not located in country N (block 1320—No), process 1300 may include proceeding with the attach procedure (1360). For example, when UE 310 is not located in a country for which UE 310 is to use optimized CA combinations, UE 310 may proceed to attach to base station 322 in a more standardized or traditional way (e.g., without using an optimized CA combination configured for the country/operator) (block 1360). When UE 310 is located in country N (block 1320—Yes), process 1300 may include loading an optimized CA list (e.g., a CA optimization file) (block 1330). The optimized CA list may include one or more CA combinations (C) associated with one or more bands (B) and a corresponding CBW. UE 310 may process with CA combinations of the optimized CA list determine a suitable CA combination for communicating with base station 322. This may include processing the CA combinations of the optimized CA list to determine or identify a CA combination (Cᵢ)ᵢ₌₁ⁿ)) with a BW that is less than or equal to a maximum CA BW of UE 310.

Process 1300 may include updating a CBW and corresponding band (B) for one or more CA combinations (C) based on the optimized CA list (at 1340). For example, UE 310 may use the optimized CA list to update the CBW per band for CA combinations. In so doing, UE 310 may be configured to use one or more optimized CA combinations for UE capability reporting, instead of for example communication standard default CA combinations and UE capability reporting processes. Process 1300 may include signaling support for the CA combination ((Cᵢ)ᵢ₌₁ⁿ) (block 1350) and continuing with the attach procedure (block 1360). For example, UE 310 may signal to base station 322 that UE 310 supports the CA combination and proceed with completing the attach procedure.

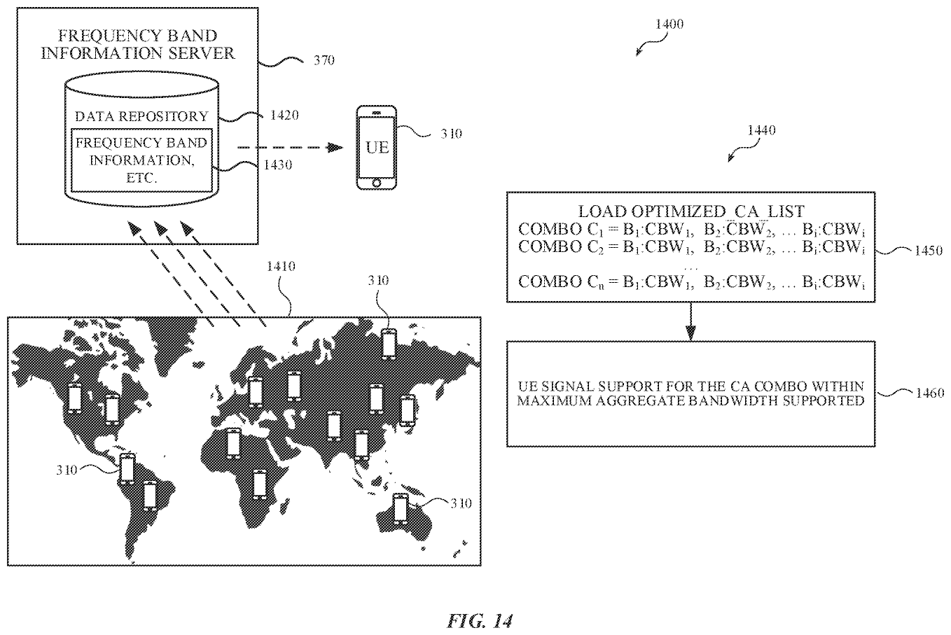

FIG. 14 is a diagram of an example 1400 of dynamically reporting UE CA capability according to one or more implementations described herein. As shown, there may be multiple frameworks configured to collect cellular information (e.g., frequency band information 1430) from UEs 310 in the field and store the information in a centralized data repository 1420 (e.g., one or more servers connected to one or more databases). The information could be a collection of: Cell-ID, location, frequency band information, etc. For example, UEs 310 may report the carrier BW of bands collocated at a given location or cell, and the information may be processes, organized, arranged, and stored in a centralized data repository 1420 with such data coming from all types of UEs 310 in locations 1410 throughout a city, county, state, province, country, hemisphere, the world, etc. With this information, UE 310 may be able to acquire information (e.g., actual maximum CBW per band, etc.) a priori of a current cell by accessing the centralized data repository or database.

As shown by the diagram 1440, UE 310 may then use the information to optimize carrier component BW accordingly in order to signal support for an appropriate and optimized CA combination. The information may be distributed to UEs 310 via an optimized CA list 1450 (or another type of data structure and storage solution). The optimized CA list 1450 may be associated with a cell, base station, operator, country, etc., and may include one or more CA combinations (C) associated with one or more bands (B) and corresponding channel BWs. Upon entering the cell, detecting the base station, entering an operator's network or a country, UE 310 may load the optimized CA list into memory (e.g., from storage or downloaded from data repository 1420) and use the optimized CA list to determine a suitable CA combination (e.g., a CA combination within a maximum aggregated bandwidth supported by UE) and signal to the network that the CA combination is supported (block 1460). Accordingly, one or more of the techniques described herein may involve UEs 310 from around the world providing cellular and network information to a centralized server and data repository and the aggregated data being processed and distributed to UEs 310 to enable UEs 31- to dynamically report UE CA capability information as described herein.

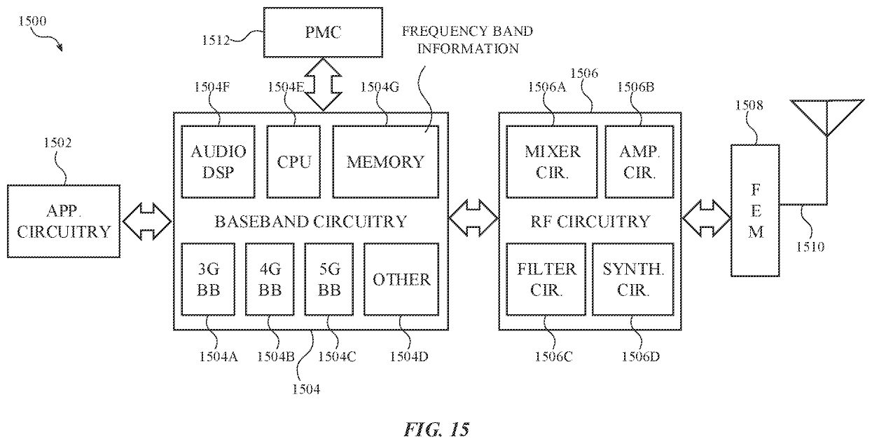

FIG. 15 is a diagram of an example of components of a device according to one or more implementations described herein. In some implementations, the device 1500 can include application circuitry 1502, baseband circuitry 1504, RF circuitry 1506, front-end module (FEM) circuitry 1508, one or more antennas 1510, and power management circuitry (PMC) 1512 coupled together at least as shown. The components of the illustrated device 1500 can be included in a UE or a RAN node. In some implementations, the device 1500 can include fewer elements (e.g., a RAN node may not utilize application circuitry 1502, and instead include a processor/controller to process IP data received from a CN or an Evolved Packet Core (EPC)). In some implementations, the device 1500 can include additional elements such as, for example, memory/storage, display, camera, sensor (including one or more temperature sensors, such as a single temperature sensor, a plurality of temperature sensors at different locations in device 1500, etc.), or input/output (I/O) interface. In other implementations, the components described below can be included in more than one device (e.g., said circuitries can be separately included in more than one device for Cloud-RAN (C-RAN) implementations).

The application circuitry 1502 can include one or more application processors. For example, the application circuitry 1502 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1500. In some implementations, processors of application circuitry 1502 can process IP data packets received from an EPC.

The baseband circuitry 1504 can include circuitry such as, but not limited to, one or more single-core or multi-core processors. The baseband circuitry 1504 can include one or more baseband processors or control logic to process baseband signals received from a receive signal path of the RF circuitry 1506 and to generate baseband signals for a transmit signal path of the RF circuitry 1506. Baseband circuitry 1504 can interface with the application circuitry 1502 for generation and processing of the baseband signals and for controlling operations of the RF circuitry 1506. For example, in some implementations, the baseband circuitry 1504 can include a 3G baseband processor 1504A, a 4G baseband processor 1504B, a 5G baseband processor 1504C, or other baseband processor(s) 1504D for other existing generations, generations in development or to be developed in the future (e.g., 6G, etc.). The baseband circuitry 1504 (e.g., one or more of baseband processors 1504A-D) can handle various radio control functions that enable communication with one or more radio networks via the RF circuitry 1506. In other implementations, some or all of the functionality of baseband processors 1504A-D can be included in modules stored in the memory 1504G and executed via a Central Processing Unit (CPU) 1504E. The radio control functions can include, but are not limited to, signal modulation/demodulation, encoding/decoding, radio frequency shifting, etc. In some implementations, modulation/demodulation circuitry of the baseband circuitry 1504 can include Fast-Fourier Transform (FFT), preceding, or constellation mapping/de-mapping functionality. In some implementations, encoding/decoding circuitry of the baseband circuitry 1504 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1504G may store frequency band information. In some implementations, this may include RFB information, optimized CA lists, information about CA combinations and corresponding bands and channel BWs, etc. UE 310 with baseband circuitry 1504 may use the frequency band information to perform one or more operations described herein, such as determining whether an actual maximum CA combination BW is less than or equal to a maximum CA combination BW supported by UE 310, determine a deficit (or difference between an actual maximum CA combination BW and a maximum CA combination BW supported by UE 310, determine optimized CA combinations of a particular cell or network, etc. Consequently, UE 310 may be capable of determining that a CA combination that might otherwise be assumed to be unsupported by UE 310 is in fact supported by UE 310.

In some implementations, the baseband circuitry 1504 can include one or more audio digital signal processor(s) (DSP) 1504F. The audio DSPs 1504F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1504 and the application circuitry 1502 can be implemented together such as, for example, on a system on a chip (SOC).

In some implementations, the baseband circuitry 1504 can provide for communication compatible with one or more radio technologies. For example, in some implementations, the baseband circuitry 1504 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1504 is configured to support radio communications of more than one wireless protocol can be referred to as multi-mode baseband circuitry.

RF circuitry 1506 can enable communication with wireless networks using modulated electromagnetic radiation through a non-solid medium. In various implementations, the RF circuitry 1506 can include switches, filters, amplifiers, etc. to facilitate the communication with the wireless network. RF circuitry 1506 can include a receive signal path which can include circuitry to down-convert RF signals received from the FEM circuitry 1508 and provide baseband signals to the baseband circuitry 1504. RF circuitry 1506 can also include a transmit signal path which can include circuitry to up-convert baseband signals provided by the baseband circuitry 1504 and provide RF output signals to the FEM circuitry 1508 for transmission.

In some implementations, the receive signal path of the RF circuitry 1506 can include mixer circuitry 1506A, amplifier circuitry 1506B and filter circuitry 1506C. In some implementations, the transmit signal path of the RF circuitry 1506 can include filter circuitry 1506C and mixer circuitry 1506A. RF circuitry 1506 can also include synthesizer circuitry 1506D for synthesizing a frequency for use by the mixer circuitry 1506A of the receive signal path and the transmit signal path. In some implementations, the mixer circuitry 1506A of the receive signal path can be configured to down-convert RF signals received from the FEM circuitry 1508 based on the synthesized frequency provided by synthesizer circuitry 1506D. The amplifier circuitry 1506B can be configured to amplify the down-converted signals and the filter circuitry 1506C can be a low-pass filter (LPF) or band-pass filter (BPF) configured to remove unwanted signals from the down-converted signals to generate output baseband signals. Output baseband signals can be provided to the baseband circuitry 1504 for further processing. In some implementations, the output baseband signals can be zero-frequency baseband signals, although this is not a requirement. In some implementations, mixer circuitry 1506A of the receive signal path can comprise passive mixers, although the scope of the implementations is not limited in this respect.

In some implementations, the mixer circuitry 1506A of the transmit signal path can be configured to up-convert input baseband signals based on the synthesized frequency provided by the synthesizer circuitry 1506D to generate RF output signals for the FEM circuitry 1508. The baseband signals can be provided by the baseband circuitry 1504 and can be filtered by filter circuitry 1506C.

In some implementations, the mixer circuitry 1506A of the receive signal path and the mixer circuitry 1506A of the transmit signal path can include two or more mixers and can be arranged for quadrature down conversion and up conversion, respectively. In some implementations, the mixer circuitry 1506A of the receive signal path and the mixer circuitry 1506A of the transmit signal path can include two or more mixers and can be arranged for image rejection (e.g., Hartley image rejection). In some implementations, the mixer circuitry 1506A of the receive signal path and the mixer circuitry 1506A can be arranged for direct down conversion and direct up conversion, respectively. In some implementations, the mixer circuitry 1506A of the receive signal path and the mixer circuitry 1506A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1506 can include analog-to-digital converter (ADC) and digital-to-analog converter (DAC) circuitry and the baseband circuitry 1504 can include a digital baseband interface to communicate with the RF circuitry 1506.

In some dual-mode implementations, a separate radio IC circuitry can be provided for processing signals for each spectrum, although the scope of the implementations is not limited in this respect.

In some implementations, the synthesizer circuitry 1506D can be a fractional-N synthesizer or a fractional N/N+1 synthesizer, although the scope of the implementations is not limited in this respect as other types of frequency synthesizers can be suitable. For example, synthesizer circuitry 1506D can be a delta-sigma synthesizer, a frequency multiplier, or a synthesizer comprising a phase-locked loop with a frequency divider.

The synthesizer circuitry 1506D can be configured to synthesize an output frequency for use by the mixer circuitry 1506A of the RF circuitry 1506 based on a frequency input and a divider control input. In some implementations, the synthesizer circuitry 1506D can be a fractional N/N+1 synthesizer.

In some implementations, frequency input can be provided by a voltage-controlled oscillator (VCO), although that is not a requirement. Divider control input can be provided by either the baseband circuitry 1504 or the applications circuitry 1502 depending on the desired output frequency. In some implementations, a divider control input (e.g., N) can be determined from a look-up table based on a channel indicated by the applications circuitry 1502.

Synthesizer circuitry 1506D of the RF circuitry 1506 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1506D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1506 can include an IQ/polar converter.

FEM circuitry 1508 can include a receive signal path which can include circuitry configured to operate on RF signals received from one or more antennas 1510, amplify the received signals and provide the amplified versions of the received signals to the RF circuitry 1506 for further processing. FEM circuitry 1508 can also include a transmit signal path which can include circuitry configured to amplify signals for transmission provided by the RF circuitry 1506 for transmission by one or more of the one or more antennas 1510. In various implementations, the amplification through the transmit or receive signal paths can be done solely in the RF circuitry 1506, solely in the FEM circuitry 1508, or in both the RF circuitry 1506 and the FEM circuitry 1508.

In some implementations, the FEM circuitry 1508 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1506). The transmit signal path of the FEM circuitry 1508 can include a power amplifier (PA) to amplify input RF signals (e.g., provided by RF circuitry 1506), and one or more filters to generate RF signals for subsequent transmission (e.g., by one or more of the one or more antennas 1510).

In some implementations, the PMC 1512 can manage power provided to the baseband circuitry 1504. In particular, the PMC 1512 can control power-source selection, voltage scaling, battery charging, or DC-to-DC conversion. The PMC 1512 can often be included when the device 1500 is capable of being powered by a battery, for example, when the device is included in a UE. The PMC 1512 can increase the power conversion efficiency while providing desirable implementation size and heat dissipation characteristics.

While FIG. 15 shows the PMC 1512 coupled only with the baseband circuitry 1504. However, in other implementations, the PMC 1512 may be additionally or alternatively coupled with, and perform similar power management operations for, other components such as, but not limited to, application circuitry 1502, RF circuitry 1506, or FEM circuitry 1508.

In some implementations, the PMC 1512 can control, or otherwise be part of, various power saving mechanisms of the device 1500. For example, if the device 1500 is in an RRC_Connected state, where it is still connected to the RAN node as it expects to receive traffic shortly, then it can enter a state known as Discontinuous Reception Mode (DRX) after a period of inactivity. During this state, the device 1500 can power down for brief intervals of time and thus save power.

If there is no data traffic activity for an extended period of time, then the device 1500 can transition off to an RRC_Idle state, where it disconnects from the network and does not perform operations such as channel quality feedback, handover, etc. The device 1500 goes into a very low power state and it performs paging where again it periodically wakes up to listen to the network and then powers down again. The device 1500 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1502 and processors of the baseband circuitry 1504 can be used to execute elements of one or more instances of a protocol stack. For example, processors of the baseband circuitry 1504, alone or in combination, can be used execute Layer 3, Layer 2, or Layer 1 functionality, while processors of the baseband circuitry 1504 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

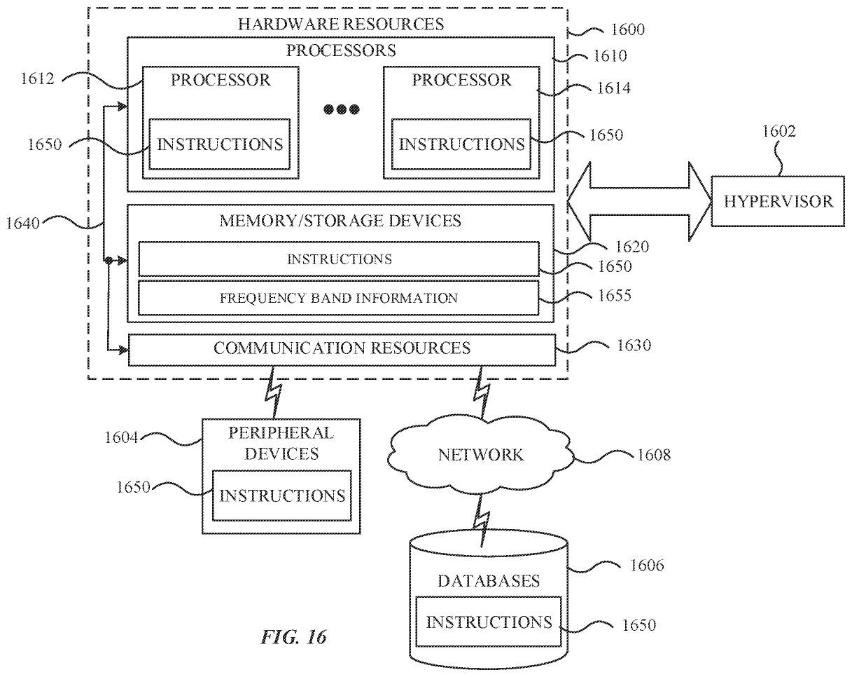

FIG. 16 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors (or processor cores) 1610, one or more memory/storage devices 1620, and one or more communication resources 1630, each of which may be communicatively coupled via a bus 1640. For embodiments where node virtualization (e.g., NFV) is utilized, a hypervisor 1602 may be executed to provide an execution environment for one or more network slices/sub-slices to utilize the hardware resources 1600

The processors 1610 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1612 and a processor 1614.

The memory/storage devices 1620 may include main memory, disk storage, or any suitable combination thereof. The memory/storage devices 1620 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1620 may store frequency band information 1655. In some implementations, this may include RFB information, optimized CA lists, information about CA combinations and corresponding bands and channel BWs, etc. UE 310 with processors 1614 may use the frequency band information 1655 to perform one or more operations described herein, such as determining whether an actual maximum CA combination BW is less than or equal to a maximum CA combination BW supported by UE 310, determine a deficit (or difference between an actual maximum CA combination BW and a maximum CA combination BW supported by UE 310, determine optimized CA combinations of a particular cell or network, etc. Consequently, UE 310 may be capable of determining that a CA combination that might otherwise be assumed to be unsupported by UE 310 is in fact supported by UE 310.

The communication resources 1630 may include interconnection or network interface components or other suitable devices to communicate with one or more peripheral devices 1604 or one or more databases 1606 via a network 1608. For example, the communication resources 1630 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1650 may comprise software, a program, an application, an applet, an app, or other executable code for causing at least any of the processors 1610 to perform any one or more of the methodologies discussed herein. The instructions 1650 may reside, completely or partially, within at least one of the processors 1610 (e.g., within the processor's cache memory), the memory/storage devices 1620, or any suitable combination thereof. Furthermore, any portion of the instructions 1650 may be transferred to the hardware resources 1600 from any combination of the peripheral devices 1604 or the databases 1606. Accordingly, the memory of processors 1610, the memory/storage devices 1620, the peripheral devices 1604, and the databases 1606 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the example described herein, a user equipment (UE), may comprise: a memory; and one or more processors configured to, when executing instructions stored in the memory, cause the UE to: receive, during an attach procedure with a network, a UE capability request message comprising actual maximum channel bandwidths (CBWs) used by a network for a plurality of carriers; determine a carrier aggregation (CA) combination comprising two or more of the plurality of carries; determine a CA combination BW for the CA combination based on the actual maximum CBWs corresponding to carriers of the CA combination; determine whether the CA combination BW is less than or equal to a maximum CBW capacity of the UE; and when the CA combination BW is less than or equal to a maximum BW capacity of the UE, signal to the network that the CA combination is supported by the UE.

In example 2, which may also include one or more of the example described herein, wherein, when the CA combination BW is not less than or equal to the maximum BW capacity of the UE, the one or more processors are configured to: determine another CA combination; determine a CA combination BW for the another CA combination; and determine whether the CA combination BW is less than or equal to a maximum BW capacity of the UE.

In example 3, which may also include one or more of the example described herein, wherein, when no CA combinations, of the plurality of carriers, are supported by the UE, the one or more processors are configured to: proceed with the attach procedure without signaling support for any of the CA combinations.

In example 4, which may also include one or more of the example described herein, wherein, the actual maximum BW comprises a channel BW deployed by the network.

In example 5, which may also include one or more of the example described herein, wherein the CA combination BW comprises a sum of actual maximum BWs of each carrier of the CA combination.

In example 6, which may also include one or more of the example described herein, wherein, when the CA combination BW is not less than or equal to the maximum BW capacity of the UE, the one or more processors are configured to: determine a deficit β by subtracting the CA combination BW from the maximum BW capacity; reduce, based on the deficit β, a BW of lower priority bands until the deficit β is equal to or less than 0; and signal to the network that the CA combination is supported by the UE.

In example 7, which may also include one or more of the example described herein, wherein BWs of frequency division duplex (FDD) bands are reduced before BWs of time division duplex (TDD) bands are reduced.

In example 8, which may also include one or more of the example described herein, wherein the BW of lower priority bands is reduced by updating bits of a channelBWs-DL information element (IE) from right to left.

In example 9, which may also include one or more of the example described herein, wherein the UE capability request message is received from a base station of the network, and the UE is configured to proceed with the attach procedure after signaling, to the base station, the CA combination supported by the UE.

In example 10, which may also include one or more of the example described herein, a user equipment (UE) may comprise: a memory; and one or more processors configured to, when executing instructions stored in the memory, cause the UE to: determine, during an attach procedure, a geographic location of the UE; determine whether the geographic location is associated with an optimized carrier aggregation (CA) list; when the geographic location is associated with an optimized CA list; update, based on the optimized CA list, channel bandwidths (CBWs) for bands (B) of at least one CA combination; and signal, to a base station, support for the at least one CA combination.

In example 11, which may also include one or more of the example described herein, wherein the one or more processors are further configured to cause the UE to: complete the attach procedure.

In example 12, which may also include one or more of the example described herein, wherein the optimized CA list is stored locally by the UE.

In example 13, which may also include one or more of the example described herein, wherein the optimized CA list is received from a centralized data repository comprising frequency band information collected from multiple UEs.

In example 14, which may also include one or more of the example described herein, wherein the one or more processors are further configured to cause the UE to: collect frequency band information and a cell ID from the base station; and communicate the frequency band information to the centralized data repository.

In example 15, which may also include one or more of the example described herein, a method, performed by a user equipment (UE), the method comprising: receiving, during an attach procedure with a network, a UE capability request message comprising actual maximum channel bandwidths (CBWs) used by a network for a plurality of carriers; determining a carrier aggregation (CA) combination comprising two or more of the plurality of carries; determining a CA combination BW for the CA combination based on the actual maximum CBWs corresponding to carriers of the CA combination; determining whether the CA combination BW is less than or equal to a maximum CBW capacity of the UE; and when the CA combination BW is less than or equal to a maximum BW capacity of the UE, signaling to the network that the CA combination is supported by the UE.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A user equipment (UE), comprising:
a memory; and
one or more processors configured to, when executing instructions stored in the memory, cause the UE to:
receive, during an attach procedure with a network, a UE capability request message comprising actual maximum channel bandwidths (CBWs) used by a network for a plurality of carriers;
determine a carrier aggregation (CA) combination comprising two or more of the plurality of carries;
determine a CA combination BW for the CA combination based on the actual maximum CBWs corresponding to carriers of the CA combination;
determine whether the CA combination BW is less than or equal to a maximum CBW capacity of the UE; and
when the CA combination BW is less than or equal to a maximum BW capacity of the UE,
signal to the network that the CA combination is supported by the UE.

2. The UE of claim 1, wherein, when the CA combination BW is not less than or equal to the maximum BW capacity of the UE, the one or more processors are configured to:
determine another CA combination;
determine a CA combination BW for the another CA combination; and
determine whether the CA combination BW is less than or equal to the maximum BW capacity of the UE.

3. The UE of claim 1, wherein, when no CA combinations, of the plurality of carriers, are supported by the UE, the one or more processors are configured to:
proceed with the attach procedure without signaling support for any of the CA combinations.

4. The UE of claim 1, wherein, the actual maximum CBWs respectively comprises a channel BW deployed by the network.

5. The UE of claim 1, wherein the CA combination BW comprises a sum of the actual maximum CBWs of each carrier of the CA combination.

6. The UE of claim 1, wherein, when the CA combination BW is not less than or equal to the maximum BW capacity of the UE, the one or more processors are configured to:
determine a deficit β by subtracting the CA combination BW from the maximum BW capacity;
reduce, based on the deficit β, a BW of lower priority bands until the deficit β is equal to or less than 0; and
signal to the network that the CA combination is supported by the UE.

7. The UE of claim 6, wherein BWs of frequency division duplex (FDD) bands are reduced before BWs of time division duplex (TDD) bands are reduced.

8. The UE of claim 7, wherein the BW of lower priority bands is reduced by updating bits of a channelBWs-DL information element (IE) from right to left.

9. The UE of claim 1, wherein the UE capability request message is received from a base station of the network, and the UE is configured to proceed with the attach procedure after signaling, to the base station, the CA combination supported by the UE.

10. A baseband processor, configured to, when executing instructions stored in one or more memories, cause a user equipment (UE) to:
determine, during an attach procedure, a geographic location of the UE;
determine whether the geographic location is associated with an optimized carrier aggregation (CA) list;
when the geographic location is associated with an optimized CA list;
update, based on the optimized CA list, channel bandwidths (CBWs) for bands (B) of at least one CA combination; and
signal, to a base station, support for the at least one CA combination.

11. The baseband processor of claim 10, further configured to cause the UE to complete the attach procedure.

12. The baseband processor of claim 10, wherein the optimized CA list is stored locally in the UE.

13. The baseband processor of claim 10, wherein the optimized CA list is received from a centralized data repository comprising frequency band information collected from multiple UEs.

14. The baseband processor of claim 13, further configured to cause the UE to:
collect frequency band information and a cell ID from the base station; and
communicate the frequency band information to the centralized data repository.

15. A method, performed by a user equipment (UE), the method comprising:
receiving, during an attach procedure with a network, a UE capability request message comprising actual maximum channel bandwidths (CBWs) used by a network for a plurality of carriers;
determining a carrier aggregation (CA) combination comprising two or more of the plurality of carries;
determining a CA combination BW for the CA combination based on the actual maximum CBWs corresponding to carriers of the CA combination;
determining whether the CA combination BW is less than or equal to a maximum CBW capacity of the UE; and
when the CA combination BW is less than or equal to a maximum BW capacity of the UE,
signaling to the network that the CA combination is supported by the UE.

16. The method of claim 15, wherein:
when the CA combination BW is not less than or equal to the maximum BW capacity of the UE, the method further comprises:
determining another CA combination;
determining a CA combination BW for the another CA combination; and
determining whether the CA combination BW is less than or equal to the maximum BW capacity of the UE.

17. The method of claim 15, wherein:
when no CA combinations, of the plurality of carriers, are supported by the UE, the method further comprises:
proceeding with the attach procedure without signaling support for any of the CA combinations.

18. The method of claim 15, wherein, the actual maximum CBWs respectively comprises a channel BW deployed by the network.

19. The method of claim 15, wherein the CA combination BW comprises a sum of actual maximum BWs of each carrier of the CA combination.

20. The method of claim 15, wherein, when the CA combination BW is not less than or equal to the maximum BW capacity of the UE, the method further comprises:
determining a deficit β by subtracting the CA combination BW from the maximum BW capacity;
reducing, based on the deficit β, a BW of lower priority bands until the deficit β is equal to or less than 0; and
signaling to the network that the CA combination is supported by the UE.
